(19) United States
(12) Patent Application Publication
(10) Pub. No.: US 2010/0236128 A1
(43) Pub. Date: Sep. 23, 2010

(54) ROLLER FISHING LINE GUIDE FOR A FISHING ROD

(76) Inventor: Rudolph Augustus Murray, Miami, FL (US)

Correspondence Address: RUBEN ALCOBA, ESQ., 3399 NW 72 AVENUE, SUITE211, MIAMI, FL, 33122, US

(21) Appl. No.: 12/409,110

(22) Filed: Mar. 23, 2009

(51) Int. Cl. A01K 87/04

(52) U.S. Cl. 43/24

(57) ABSTRACT

A roller fishing line guide device for a fishing rod, comprising inter alia, a guide frame having a rod mounting bracket configured for mounting the guide frame to a fishing rod, a guide frame body, a roller means mounting bracket and a grooved disc shaped roller means with bearings to reduce the friction resulting from repeated contact between the fishing line and the fishing line guide rings. The roller means is secured to the roller means mounting bracket using an interlocking threaded axis.

### BACKGROUND

The present device relates to fishing rods, specifically, roller guides for fishing rods that create a nearly frictionless medium for the casting and reeling in of fishing lines.

In the fishing industry, hooking a fish is only the first step to actually “catching” it. In a fishing tournament, there are no trophies given to “the one that got away.” To the great frustration of many fisherman, often, the reason that a fish gets away is due to equipment failure, specifically the fishing line snapping before the fish is close enough to secure with a gaff or net.

Most experienced fisherman are not likely to make the mistake of hooking a fish that outweighs the test strength of their fishing line; however, even the most experienced fisherman using a fishing line with the proper test strength may experience the frustration of having their fishing line snap nonetheless. The reason: friction caused by the repeated contact between the fishing line and the fishing line guide rings.

The use of the traditional series of fishing line guide rings positioned about the length of a fishing rod is a necessary evil in the fishing industry. On the one hand, the use of such guide rings positioned about the length of a fishing rod allows the fishing line to maintain its position along the length of the fishing rod at a distance from fishing reel; however, using traditional guide rings may cause damage to the fishing line.

When reeling in an extended fishing line, the fishing line must pass through and contact a series of fishing line guide rings placed about the length of the fishing rod. As the fishing line contacts each guide ring, the resulting constant friction between the fishing line and the guide rings reduces the structural integrity of the fishing line until ultimately the fishing line fails.

Generally, the fishing line contacts the guide rings about the lower surface of the fishing line or the upper surface of the fishing line, depending on whether the fishing rod is a Bait Casting Rod or a Spinning Rod, respectively.

Regardless of whether the fishing rod is a Bait Casting Rod or a Spinning Rod, the repeated contact between the fishing line and the guide rings may result in unwanted heating of the fishing line and hairline cracks in the guide ring that may cause the fishing line to fray or otherwise weaken.

The present invention was invented to address the foregoing problem. Specifically, a roller fishing line guide device for a fishing rod, comprising inter alia, a guide frame having a rod mounting bracket configured for mounting the guide frame to a fishing rod, a guide frame body, and a roller means mounting bracket configured to receive a roller means and a grooved disc shaped roller means to reduce the friction resulting from repeated contact between the fishing line and the fishing line guide rings.

When the present invention is mounted on a fishing rod, the user will realize the benefits of the traditional fishing line guide ring, i.e. the fishing line will continue to be positioned along the length of the fishing rod at a distance from the fishing reel; in addition to the traditional benefits, the present invention will effectively eliminate the damage to the fishing line.

The grooved roller means creates a lightweight, virtually frictionless contact point for the fishing line; thereby effectively eliminating the fraying or other damage that reduces the structural integrity of the fishing line.

One of the key features of the present invention is that the roller fishing line guide serves the dual purpose of providing a lightweight device for maintaining the desired position of the fishing line with respect to the fishing rod and reel while at the same time providing a virtually frictionless contact point for the fishing line.

An objective of the present invention is to provide a roller fishing line guide device that maintains the desired position of a fishing line with respect to its fishing rod and reel.

Another objective of the present invention is to provide a roller fishing line guide device that creates a virtually frictionless contact point for a fishing line.

Another objective of the present invention is to provide a roller fishing line guide with a roller means that is secured using an interlocking threaded axis.

Yet a further objective of the present invention is to provide a roller fishing line guide device that is cost effective to manufacture.

Several attempts have been made to reduce the friction created by the repeated contact between the fishing line and the guide ring, including the use of ceramic, stainless steel guide rings, and even roller means. However, the use of such guide rings with a braided type fishing line have not prevented the problem of the hairline cracks in the guide rings and the resulting damage to the fishing line. U.S. Pat. No. 5,276,991 (discloses a lightweight roller guide and tip for fishing rods using a spring element to secure the roller means. The use of a spring element as a fastening means is less secure than the interlocking threaded axis contemplated in the present invention

The “big game” fishing industry, i.e. marlin, tuna, shark, has attempted to solve the friction problem using big game roller guides comprising of large, heavy roller systems adapted for big game fishing rods. However, due to the unique needs of the big game industry, the big game roller guides are not readily adaptable to Bait Casting Rods and Spinner Rods due to their size, weight, and configuration.

For the foregoing reasons there exists a need for a roller fishing line guide device for a fishing rod, comprising inter alia, a guide frame having a rod mounting bracket configured for mounting the guide frame to a fishing rod, a guide frame body, and a roller means mounting bracket configured to receive a roller means and a grooved disc shaped roller means with bearings to reduce the friction resulting from repeated contact between the fishing line and the fishing line guide rings.

### SUMMARY

A roller fishing line guide device for a fishing rod, comprising inter alia, a guide frame having a rod mounting bracket configured for mounting the guide frame to a fishing rod, a guide frame body, and a roller means mounting bracket and a grooved disc shaped roller means with bearings to reduce the friction resulting from repeated contact between the fishing line and the fishing line guide rings wherein the roller means is secured to the roller means mounting bracket using an interlocking threaded axis.

When the present invention is mounted on a fishing rod, the user will realize the benefits of the traditional fishing line guide ring, i.e. the fishing line will continue to be positioned along the length of the fishing rod at a distance from the fishing reel; in addition to the traditional benefits, the present invention will effectively eliminate the damage to the fishing line.

The grooved roller means with bearings creates a lightweight, virtually frictionless contact point for the fishing line; thereby effectively eliminating the fraying or other damage that reduces the structural integrity of the fishing line.

One of the key features of the present invention is that the roller fishing line guide serves the dual purpose of providing a lightweight device for maintaining the desired position of the fishing line with respect to the fishing rod and reel while at the same time providing a virtually frictionless contact point for the fishing line. Furthermore the interlocking threaded axis fastening means provides a secure lightweight and sturdy means to secure the roller to the roller means mounting bracket.

### DRAWINGS

These and other features, aspects, and advantages of the present invention will become better understood with regard to the following description, appended claims and drawings where:

FIG. 1A, shows a front plan view of one embodiment of the device;

FIG. 1B, shows a side perspective view of one embodiment of the device;

FIG. 2A, shows an exploded cross sectional side view of one embodiment of the roller means assembly of the device;

FIG. 2B, shows a non exploded cross sectional side view of one embodiment of the roller means assembly of the device;

FIG. 3, shows a bait casting type fishing rod with one embodiment of the device appearing thereon;

FIG. 4A, shows a shows a front plan view of another embodiment of the device;

FIG. 4B, shows a side perspective view of another embodiment of the device;

FIG. 5, shows a shows a front plan view of another embodiment of the device; and

FIG. 6, shows a spinning reel type fishing rod with one embodiment of the device appearing thereon.

### DESCRIPTION

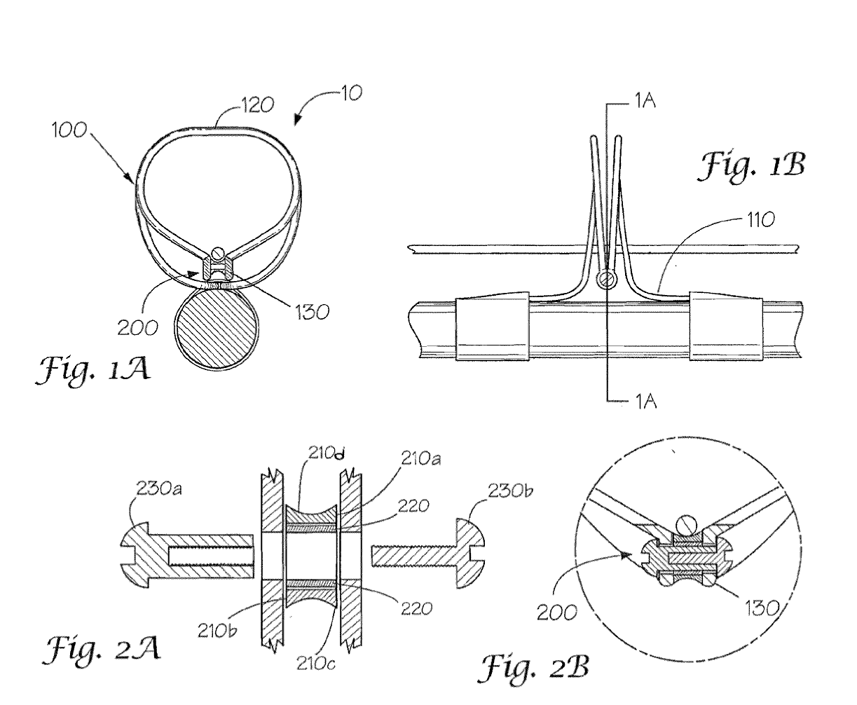

As shown in FIGS. 1a and 1b, a roller fishing line guide device for a fishing rod 10, the device 10, comprises a guide frame assembly 100 and roller means assembly 200.

The guide frame assembly 100 comprises of a rod mounting bracket 110 configured for mounting the guide frame assembly 100 to a fishing rod, a guide frame body 120, and a roller means mounting bracket 130.

The roller means assembly 200 comprises of a grooved disc shaped member 210, a bearings 220, and an interlocking threaded axis 230a and 230b. The grooved disc shaped member 210 has a first surface 210a, a second surface 210b, a central bore (not shown) that traverses the first and second surface, an edge 210c, and a concave groove 210d, the concave groove 210d spans the edge of the grooved disc shaped member 210. The bearings 220 are housed within the grooved disc shaped member 210. As seen in FIG. 2A-2B, the roller means assembly 200 is secured to the roller means mounting bracket 130 using an interlocking threaded axis 230a and 230b.

It is envisioned that the device 10, might be composed of a non corrosive material, such as stainless steel, or a material with similar non corrosive properties as stainless steel.

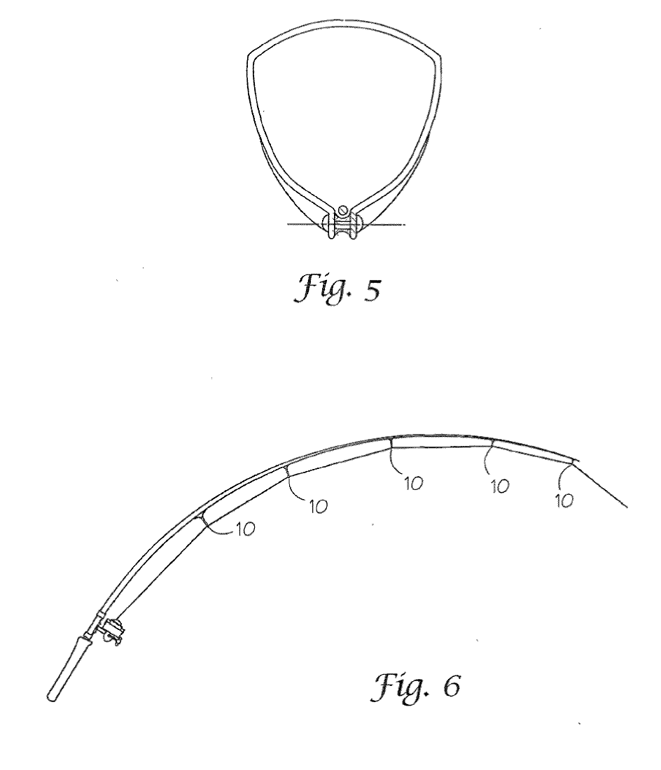

It is further envisioned that the guide frame assembly 100 and the roller means assembly 200 might be manufactured in varying sizes and shapes including a substantially circular shaped embodiment, See FIG. 1A; a substantially oval shaped embodiment, See FIG. 4a; and a substantially triangular shaped embodiment, See FIG. 5.

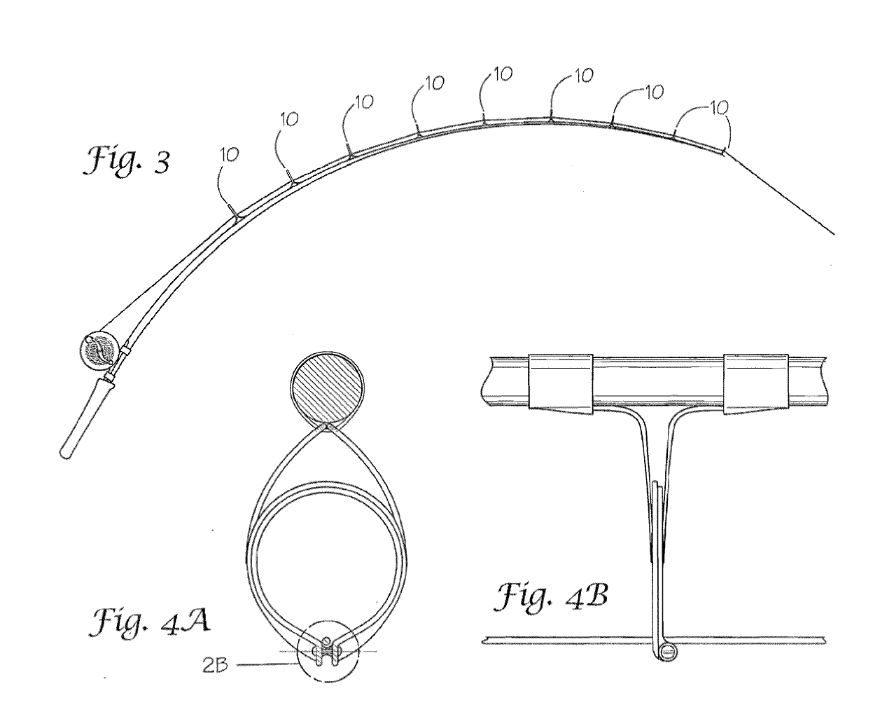

In one embodiment of the device 10, the roller means mounting bracket 130 is located on the guide frame body 120 at a position proximal to the rod mounting bracket 110. See FIG. 1A. This configuration is commonly used in bait casting type fishing rods. As depicted in FIG. 3, a series of roller devices 10 of progressively smaller sizes are positioned along the length of a fishing rod.

As the fishing line is reeled in, the fishing line contacts the grooved disc shaped member 210 of the roller means assembly 200 as the grooved disc shaped member 210 rotates about the interlocking threaded axis 230a and 230b. As depicted in FIG. 3, the weight of the fish will cause the fishing rod to bend downward; however, as the fishing line is contacting the disc shaped roller member 210 which is in turn rotating about the interlocking threaded axis 230a and 230b, a virtually frictionless contact is made with the fishing line. As virtually no friction is created between the fishing line and the disc shaped roller member 210, the risk of damage to the fishing line is greatly reduced.

In another embodiment of the device 10, the roller means mounting bracket 130 is located on the guide frame body 120 at a position distal to the rod mounting bracket 110. See FIG. 4A. This configuration is commonly used in spinning reel type fishing rods. As depicted in FIG. 6, a series of roller devices 10 of progressively smaller sizes are positioned along the length of a fishing rod.

As the fishing line is reeled in, the fishing line contacts the grooved disc shaped member 210 of the roller means assembly 200 as the grooved disc shaped member 210 rotates about the interlocking threaded axis 230a and 230b. As depicted in FIG. 6, the weight of the fish will cause the fishing rod to bend downward; however, as the fishing line is contacting the disc shaped roller member 210 which is in turn rotating about the interlocking threaded axis 230a and 230b, a virtually frictionless contact is made with the fishing line. As virtually no friction is created between the fishing line and the disc shaped roller member 210, the risk of damage to the fishing line is greatly reduced.

In either embodiment of the device 10, the use of an interlocking threaded axis 230a and 230b, as seen in FIG. 2, secures the roller means assembly 200 to the roller means mounting bracket 130 while at the same time providing a stable axis capable of withstanding the force exerted by a flailing fish as it is reeled in.

An advantage of the present invention is that it provides a roller fishing line guide device that maintains the desired position of a fishing line with respect to its fishing rod and reel.

Another advantage of the present invention is that it provides a roller fishing line guide device that creates a virtually frictionless contact point for a fishing line.

Another advantage of the present invention is that it provides a roller fishing line guide with a roller means that is secured using an interlocking threaded axis.

Yet a further advantage of the present invention is that it provides a roller fishing line guide device that is cost effective to manufacture.

Although the present invention has been described in considerable detail with reference to certain preferred versions thereof, other versions are possible. Therefore, the spirit and the scope of the claims should not be limited to the description of the preferred versions contained herein.

What is claimed is:

1. A roller fishing line guide device for a fishing rod, the roller fishing line guide device comprising;
a guide frame assembly, the guide frame assembly comprises of a rod mounting bracket configured for mounting the guide frame to a fishing rod, a guide frame body, and a roller means mounting bracket; and
a roller means assembly attached to the roller means mounting bracket, the roller means assembly comprises of a grooved disc shaped member and a bearings, the grooved disc shaped member has a first surface, a second surface, a central bore that traverses the first and second surface, an edge, and a concave groove, the concave groove spans the edge of the grooved disc shaped member and the bearings are housed within the grooved disc shaped member, the roller means assembly is secured to the roller means mounting bracket using an interlocking threaded axis.

2. The device of claim 1, wherein the roller means mounting bracket is located on the guide frame body at a position proximal to the rod mounting bracket.

3. The device of claim 2, wherein the device is composed of a non-corrosive material.

4. The device of claim 3, wherein the device is composed of stainless steel.

5. The device of claim 4, wherein the guide frame body is substantially circular in shape.

6. The device of claim 5, wherein the guide frame body is substantially oval in shape.

7. The device of claim 6, wherein the guide frame body is substantially triangular in shape.

8. The device of claim 7, wherein the roller means mounting bracket is located on the guide frame body at a posit ion distal to the rod mounting bracket.

9. The device of claim 8, wherein the device is composed of a non-corrosive material.

10. The device of claim 9, wherein the device is composed of stainless steel.

11. The device of claim 10, wherein the guide frame body is substantially circular in shape.

12. The device of claim 11, wherein the guide frame body is substantially oval in shape.

13. The device of claim 12, wherein the guide frame body is substantially triangular in shape.
